(19) United States
(12) Patent Application Publication
(10) Pub. No.: US 2002/0149352 A1
(43) Pub. Date: Oct. 17, 2002

(54) Multifunction control input for a boost voltage controller and method of using

(75) Inventor: Hok Sun Ling, Hong Kong (CN)

Correspondence Address: Robert D. Atkins, ON Semiconductor, Patent Administration Dept-MD A230, P.O. Box 62890, Phoenix, AZ, 85082-2890, US

(73) Assignee: Semiconductor Components Industries, LLC.

(21) Appl. No.: 09/825,781

(22) Filed: Apr. 5, 2001

(51) Int. Cl. G05F 1/40

(52) U.S. Cl. 323/283

(57) ABSTRACT

DC to DC boost converters (10 and 54) utilize boost controllers (12 and 28) which provide multifunctional IC pins (LB/\overline{SHDN} and FB/\overline{SHDN}) . Boost controller (12) allows the combination of a low battery sense function and an IC shutdown function to be implemented with a single pin (LB/\overline{SHDN}) . Boost controller (28) allows the combination of an output voltage feedback function and an IC shutdown function to be implemented with a single pin (FB/\overline{SHDN}). DC to DC boost controllers (12 and 28) facilitate smaller package sizes due to the reduction of I/O pins required.

### BACKGROUND OF THE INVENTION

The present invention relates in general to multi-functional control inputs for a boost voltage controller and, more particularly, to combination low battery sense input/Integrated Circuit (IC) shutdown and output voltage feedback/IC shutdown control inputs for boost voltage converters.

Portable electronic devices are becoming increasingly popular in proportion to the number of mobile users who require them. As the need to facilitate information exchange and communication between mobile users increases, portable electronic devices such as cellular telephones, pagers and personal electronic organizers become increasingly pervasive. Naturally, users of the portable electronic devices demand reduced size and power consumption in order to facilitate transport and to prolong battery life.

In order to reduce size of the portable electronic devices, internal electronic packages within the portable electronic devices are reduced in size. One method used for size reduction of the internal electronic packages, is reduction of the number of Input/Output (I/O) pins required by the electronic device, also known as pin count reduction. I/O pins are required, for example, by Direct Current (DC) to DC boost converters to accommodate input and output voltages, output voltage feedback, operating potential input and shutdown control input signals, to name only a few.

Prior art attempts to reduce the pin count of electronic devices is provided by simply reducing the number of pins for the electronic package at the sacrifice of functionality. A typical reduced pin count for prior art DC to DC boost controller IC's is eight pins, for example. Reduced functionality, however, is the result of the reduced pin count. Other prior art DC to DC boost converters provide full functionality, but require a ten pin package, for example.

Hence, there is a need for a full function DC to DC boost controller package, which also provides reduced pin count to accommodate a reduction in overall package size.

### BRIEF DESCRIPTION OF THE DRAWINGS

FIG. 1 is a block diagram illustrating a DC to DC boost converter with a boost controller having integrated low battery and IC shutdown pins;

FIG. 2 is a block diagram illustrating a DC to DC boost converter with a boost controller having integrated output voltage feedback and IC shutdown pins;

FIG. 3 is a schematic of the boost controller of FIG. 1; and

FIG. 4 is a schematic of the boost controller of FIG. 2.

### DETAILED DESCRIPTION OF THE DRAWINGS

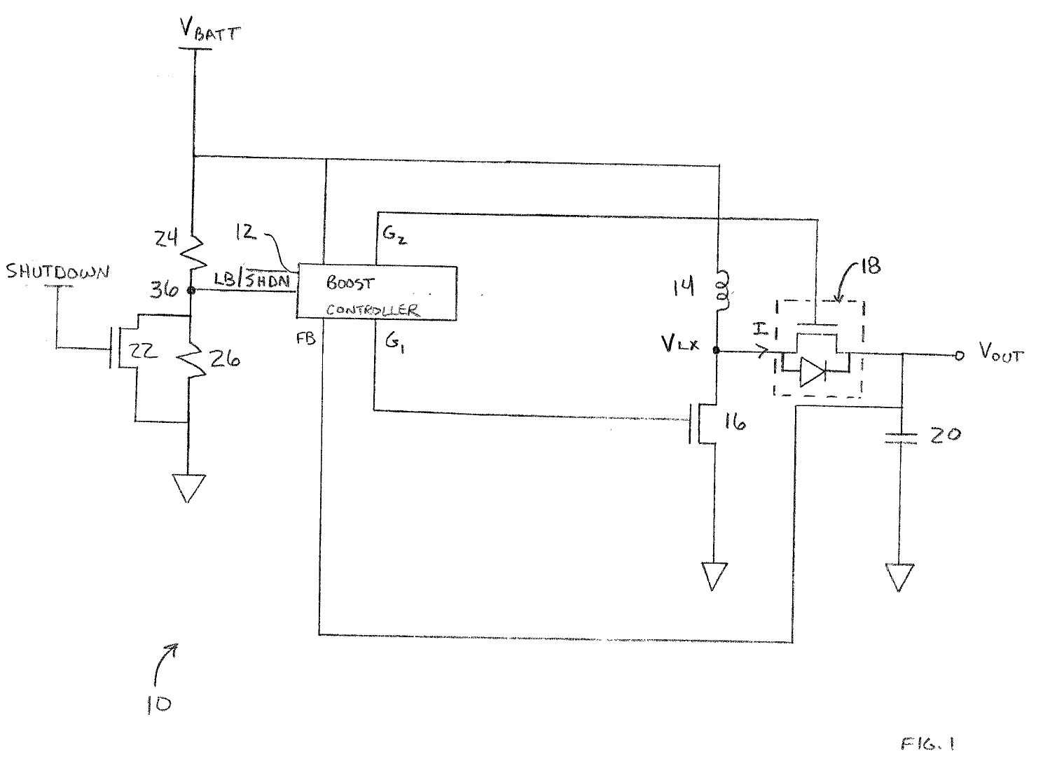

FIG. 1 illustrates DC to DC converter 10 in boost configuration, whereby the magnitude of Vₒᵤₜ exceeds the magnitude of V_{batt}, in boost conversion mode. Boost controller 12 provides logic signals G₁ and G₂ to the gate terminals of transistors 16 and 18, respectively. Transistors 16 and 18 cooperate to control current I, charging capacitor 20 to the regulated output voltage Vₒᵤₜ. In operation, boost converter 10 regulates the voltage present at terminal Vₒᵤₜ to a level predetermined by boost controller 12. Boost controller 12 is suitable for implementation in, for example, an 8 pin IC package.

A first conductor of resistor 24 is coupled to node V_{batt} and a second conductor of resistor 24 is coupled to a first conductor of resistor 26 and a first conductor of transistor 22 at pin LB/\overline{SHDN}. Second conductors of transistor 22 and resistor 26 are coupled to a second supply potential, for example, ground potential. Signal SHUTDOWN is coupled to the control terminal of transistor 22. Boost controller 12 receives the battery potential at node V_{batt}. A first conductor of inductor 14 is coupled to node V_{batt}. A second conductor of inductor 14 is coupled to a first conductor of transistors 16 and 18 at node V_{LX}. A second conductor of transistor 16 is coupled to a second supply potential, for example, ground potential. A second conductor of transistor 18 is coupled to node Vₒᵤₜ, a first conductor of capacitor 20 and pin FB of boost controller 12. A second conductor of capacitor 20 is coupled to a second supply potential, for example, ground potential.

In a first phase of operation, transistor 16 is conductive in response to the gate drive signal G₁ and transistor 18 is non-conductive in response to signal G₂. Node V_{LX} is substantially set to ground potential when transistor 16 is conductive, since a first terminal of transistor 16 is coupled to, for example, ground potential. During a time T₁, magnetic energy is stored by inductor 14 during the conductive state of transistor 16. Switch control 12 then provides control signals G1 and G2 such that transistors 16 and 18 are rendered non-conductive and conductive, respectively, at a time T₂, to begin a second phase of operation. At the end of time T₁, transistor 16 is rendered non-conductive. Since the current induced by the build up of magnetic energy within inductor 14 can not change instantaneously, the voltage at node V_{LX} increases until the intrinsic forward body diode of transistor 18 is rendered conductive, where V_{LX}=Vₒᵤₜ+0.7V. Current is allowed to flow from V_{batt} to Vₒᵤₜ through inductor 14 and the body diode of transistor 18. Transistor 18 is then rendered conductive by control signal G₂ to provide a less resistive current path.

An important feature of boost controller 12 is that the low battery and shutdown signals are integrated into a single pin LB/\overline{SHDN}. Under normal operation, the voltage at node 36 is at a voltage higher than the low battery threshold voltage, for example 0.8 volts, required to trigger a low battery voltage alarm. Under a shutdown condition, an external signal SHUTDOWN is asserted and renders transistor 22 conductive. Resistor 26 is substantially shorted to ground potential, which provides a voltage at node 36, which is lower than the shutdown voltage threshold, for example, 0.2 volts. It can be seen, therefore, that utilization of pin LB/\overline{SHDN} reduces the pin count of boost controller 12 by one, while maintaining full IC shutdown and low voltage functionality.

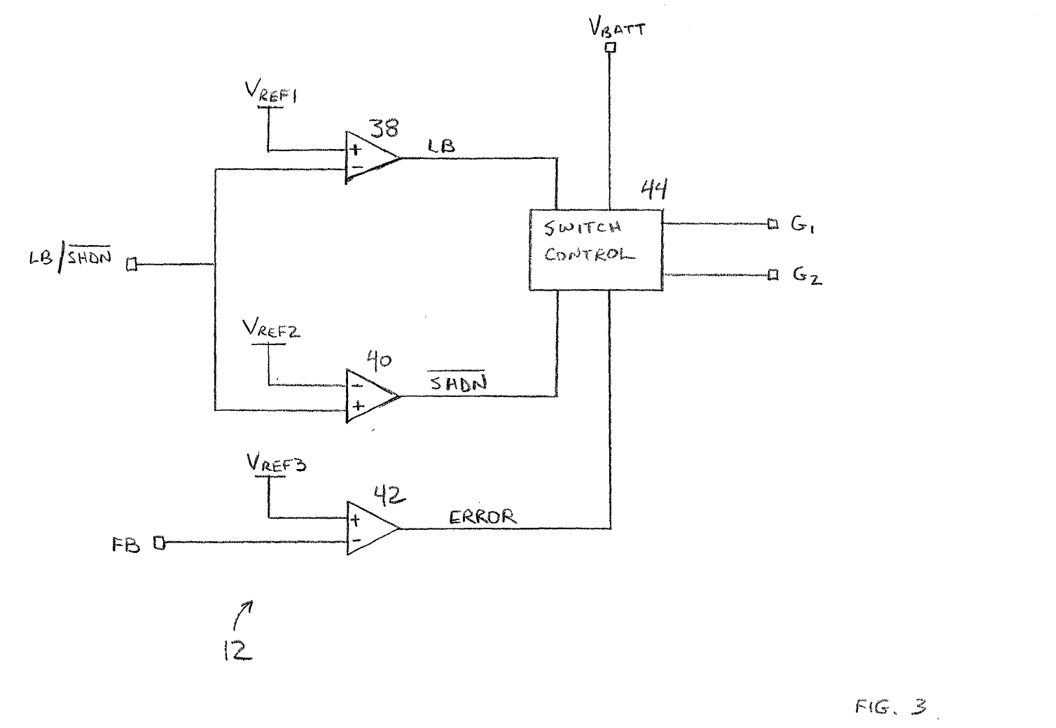

FIG. 3 illustrates boost controller 12 of DC to DC boost converter 10 operating in a Pulse Frequency Modulation (PFM) mode of operation. Pin LB/\overline{SHDN} is coupled to the inverting input of comparator 38 and to the non-inverting input of comparator 40. The non-inverting input of comparator 38 is coupled to V_{ref1}. The inverting input of comparator 40 is coupled to V_{ref2}. The non-inverting input of comparator 42 is coupled to V_{ref3}. The output of comparator 38 provides signal LB and is coupled to switch control 44. The output of comparator 40 provides signal \overline{SHDN} and is coupled to switch control 44. The output of comparator 42 provides signal ERROR and is coupled to switch control 44. Nodes G₁ and G₂ are coupled to switch control 44.

In normal operation, comparators 38 and 40 monitor pin LB/\overline{SHDN} simultaneously. The voltage at pin LB/\overline{SHDN} normally operates above V_{ref1}, which, for example, is set to 0.8 volts. Signals LB and \overline{SHDN} are logic low and logic high, respectively, since the voltage at pin LB/\overline{SHDN} is greater than V_{ref1} and greater than V_{ref2}, which is set to 0.2 volts, for example. Switch control 44 receives signals LB and \overline{SHDN} allowing normal operation of gate drive signals G₁ and G₂. Signal FB is an analog signal representative of the magnitude of the voltage at node Vₒᵤₜ and is monitored by comparator 42. Once signal FB falls below V_{ref3}, signal ERROR asserts to a logic high, causing switch control 44 to invoke a new switching cycle. Once capacitor 20 has reached the predetermined voltage, signal FB rises above V_{ref3}, which un-asserts signal ERROR, causing switch control 44 to disable switching. As current loading from capacitor 20 increases, the assertion duration of signal ERROR increases, which increases the switching frequency of switch control 44. Switching frequency is modulated by the loading level, giving rise to the principle of PFM voltage control.

If boost converter 10 is operating with Pulse Width Modulation (PWM) voltage control, the switching frequency remains constant and the gate drive pulse width of signal G₁ is modulated. Comparator 42 is replaced with an operational amplifier and signals V_{ref3} and FB are coupled as shown in FIG. 3. Signal ERROR becomes an analog voltage signal during the PWM voltage control algorithm, responsive the analog FB signal. If analog signal FB falls below V_{ref3}, the magnitude of signal ERROR increases, resulting in an increase of the conduction time of transistor 16 due to gate drive signal G₁. The voltage across capacitor 20 increases in response to the extended conduction time of transistor 16. Conversely, if analog signal FB rises above V_{ref3}, the magnitude of signal ERROR decreases, resulting in a decrease of the conduction time of transistor 16 due to gate drive signal G₁. The voltage across capacitor 20, therefore, decreases in response to the reduced conduction time of transistor 16. Switching duty cycle is modulated by the loading level, giving rise to the principle of PWM voltage control.

In a low battery operation, the voltage at pin LB/\overline{SHDN} falls below reference voltage V_{ref1}, which is set to 0.8 volts, for example. Once the voltage at pin LB/\overline{SHDN} falls below V_{ref1}, signal LB asserts to a logic high and switch control 44 takes appropriate action. In a shutdown operation, signal SHUTDOWN is asserted to a logic high by an external source such as a microprocessor or a power switch. Once asserted, signal SHUTDOWN renders transistor 22 conductive, substantially shorting node 36 to ground potential, causing the non-inverting input of comparator 40 to fall below the inverting input of comparator 40, asserting signal \overline{SHDN} to a logic low. Signal LB is also asserted to a logic high, due to the operation of comparator 38, but logic internal to switch control 44, discerns the logic state to be the IC shutdown state, as opposed to, the low battery state. Pin LB/\overline{SHDN}, therefore, serves a dual function for boost controller 12. A first function serving to detect a low battery state of boost converter 10 and a second function serving to provide an external shutdown capability for boost converter 10.

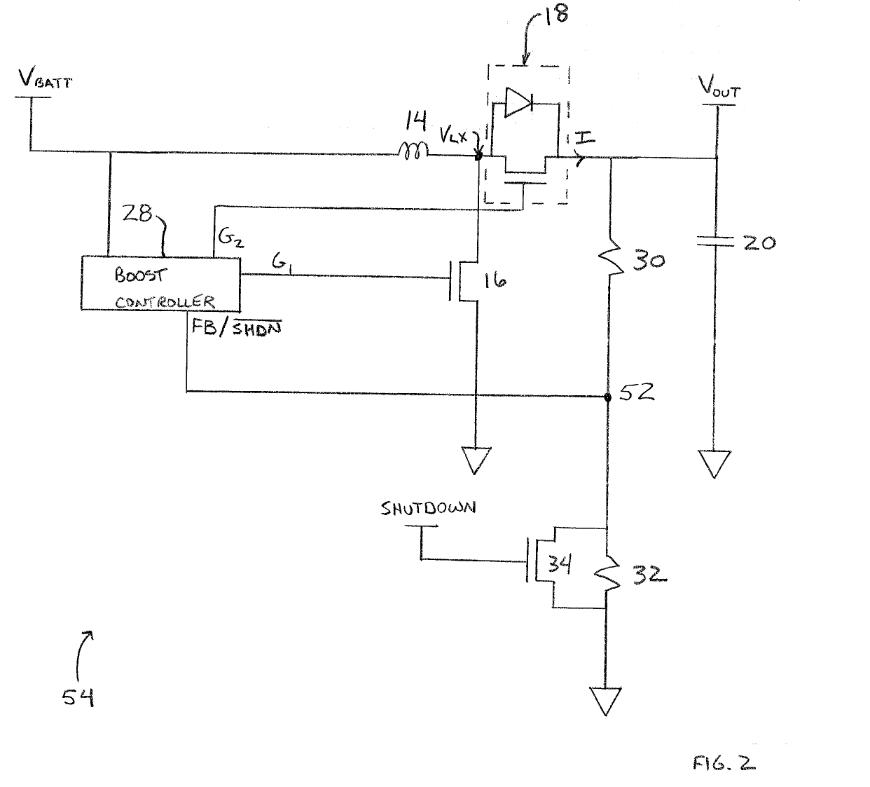

FIG. 2 illustrates DC to DC converter 54 in boost configuration, whereby the magnitude of Vₒᵤₜ exceeds the magnitude of V_{batt}, in boost conversion mode. Boost controller 28 provides logic signals G₁ and G₂ to the gate terminals of transistors 16 and 18, respectively. Transistors 16 and 18 cooperate to control current I, charging capacitor 20 to the regulated output voltage Vₒᵤₜ. In operation, boost converter 54 regulates the voltage present at terminal Vₒᵤₜ to a level predetermined by boost controller 28. It should be noted that reference designations are reused, indicating that the same components are used throughout FIGS. 1-4.

A first conductor of resistor 30 is coupled to node Vₒᵤₜ and a second conductor of resistor 30 is coupled to a first conductor of resistor 32 and a first conductor of transistor 34 at pin FB/\overline{SHDN}. Second conductors of transistor 34 and resistor 32 are coupled to a second supply potential, for example, ground potential. Signal SHUTDOWN is coupled to the control terminal of transistor 34. Boost controller 28 receives the battery potential at node V_{batt}. A first conductor of inductor 14 is coupled to node V_{batt}. A second conductor of inductor 14 is coupled to a first conductor of transistors 16 and 18 at node V_{LX}. A second conductor of transistor 16 is coupled to a second supply potential, for example, ground potential. A second conductor of transistor 18 is coupled to node Vₒᵤₜ, a first conductor of capacitor 20 and a first conductor of resistor 30. A second conductor of capacitor 20 is coupled to a second supply potential, for example, ground potential.

In a first phase of operation of boost converter 54, transistor 16 is conductive in response to the gate drive signal G₁ and transistor 18 is non-conductive in response to signal G₂. Node V_{LX} is substantially set to ground potential when transistor 16 is conductive, since a first terminal of transistor 16 is coupled to, for example, ground potential. During a time T₁, magnetic energy is stored by inductor 14 during the conductive state of transistor 16. Boost controller 28 provides control signals G1 and G2 such that transistors 16 and 18 are rendered non-conductive and conductive, respectively, at a time T₂, to begin a second phase of operation. At the end of time T₁, transistor 16 is rendered non-conductive. Since the current induced by the build up of magnetic energy within inductor 14 can not change instantaneously, the voltage at node V_{LX} increases until the intrinsic forward body diode of transistor 18 is rendered conductive, where V_{LX}=Vₒᵤₜ+0.7V. Current is allowed to flow from V_{batt} to Vₒᵤₜ through inductor 14 and the body diode of transistor 18 and transistor 18 is rendered conductive by control signal G₂ to provide a less resistive current path.

An important feature of boost converter 54 is that the output voltage feedback and shutdown signals are integrated into a single pin FB/\overline{SHDN}. To startup boost converter 54 from shutdown, external signal SHUTDOWN de-asserts to a logic low level, rendering transistor 34 non-conductive. The intrinsic forward body diode of transistor 18 biases node Vₒᵤₜ to substantially the magnitude of Vₒᵤₜ=V_{batt}−0.7 volts, where 0.7 volts is the drop across the intrinsic forward body diode of transistor 18. The voltage at node 52 exceeds the IC shutdown voltage threshold, for example, 0.2 volts, resulting in the startup of boost converter 54. Under normal operation, the feedback voltage at node 52 is at a voltage higher than the voltage required to trigger an IC shutdown. Under a shutdown condition, an external signal SHUTDOWN is asserted, which renders transistor 34 conductive. Resistor 32 is substantially shorted to ground potential, which provides a voltage at node 52, which is lower than the IC shutdown voltage threshold, for example, 0.2 volts. It can be seen, therefore, that utilization of pin FB/\overline{SHDN} reduces the pin count of boost controller 28 by one, while maintaining full output voltage feedback and IC shutdown functionality.

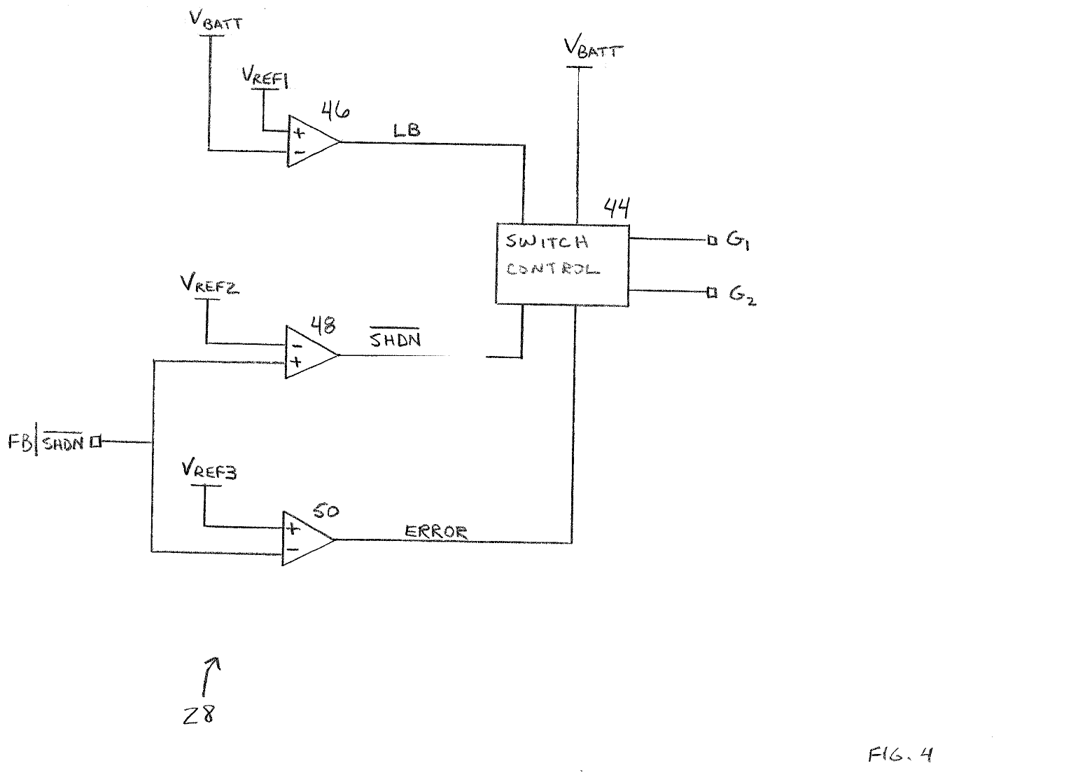

FIG. 4 illustrates boost controller 28 of DC to DC boost converter 54. Comparator 46 receives V_{ref1} and V_{batt} at the non-inverting and inverting inputs, respectively. The output of comparator 46 provides signal LB to switch control 44. Pin FB/\overline{SHDN} is coupled to the inverting input to comparator 50 and to the non-inverting input to comparator 48. The inverting input to comparator 48 is coupled to V_{ref2}. The non-inverting input to comparator 50 is coupled to V_{ref3}. The output of comparator 48 provides signal \overline{SHDN} and is coupled to switch control 44. The output of comparator 50 provides signal ERROR and is coupled to switch control 44. Nodes G₁ and G₂ are coupled to switch control 44.

In normal operation, comparators 48 and 50 monitor pin FB/\overline{SHDN} simultaneously. The voltage at pin FB/\overline{SHDN} normally operates above V_{ref2}, which, for example, is set to 0.2 volts. Signal \overline{SHDN} is at a logic high, since the voltage at pin FB/\overline{SHDN} is greater than V_{ref2}. Switch control 44 receives signals ERROR and \overline{SHDN} allowing normal operation of gate drive signals G₁ and G₂. The analog signal at pin FB/\overline{SHDN}, FB, is representative of the magnitude of the voltage at node Vₒᵤₜ during normal operation of boost converter 54 and is monitored by comparator 50 in a PFM mode of operation. Once analog signal FB falls below V_{ref3}, digital signal ERROR asserts to a logic high, causing switch control 44 to invoke a new switching cycle. The PFM algorithm operates to control gate drive signals G₁ and G₂ in order to control current I, such that capacitor 20 is charged to the required predetermined output voltage, Vₒᵤₜ. Once capacitor 20 has reached the predetermined voltage, analog signal FB rises above V_{ref3}, which un-asserts digital signal ERROR, causing switch control 44 to disable the switching of transistors 16 and 18. Disabling switching of transistors 16 and 18 requires capacitor 20 to supply the required power to the load (not shown), which is connected to node Vₒᵤₜ, until signal FB falls below V_{ref3}. A PWM algorithm can also be applied with comparator 50 being replaced by an operational amplifier with the same connections as shown in FIG. 4. Signal ERROR becomes an analog voltage signal during the PWM mode of operation, responsive to an analog feedback signal FB. If signal FB falls below V_{ref3}, the magnitude of signal ERROR increases, resulting in an increased conduction time of transistor 16, which causes an increase in voltage across capacitor 20. Conversely, if signal FB rises above V_{ref3}, the magnitude of signal ERROR decreases, resulting in a decreased conduction time of transistor 16, which causes a decrease in voltage across capacitor 20. Switching duty cycle is modulated by the loading level, consistent with PWM control of output voltage.

In a shutdown operation, digital signal SHUTDOWN is asserted, at pin FB/\overline{SHDN}, to a logic high by an external source such as a microprocessor or a power switch. Once asserted, digital signal SHUTDOWN renders transistor 34 conductive, substantially shorting node 52 to ground potential, causing the non-inverting input of comparator 48 to fall below the inverting input of comparator 48, asserting signal \overline{SHDN} to a logic low. Switch control 44 renders gate control signals G₁ and G₂ inactive upon receipt of the asserted \overline{SHDN} signal. Pin FB/\overline{SHDN}, therefore, serves a dual function for boost controller 28. A first function serving to receive an output feedback voltage of boost converter 54 under normal operation and a second function serving to provide an external shutdown capability for boost converter 54.

By now it is appreciated that pin count reduction of a DC to DC boost converter is accomplished by providing multiple functions using a single pin. Specifically, a low voltage sense function is combined with an IC shutdown function. Additionally, an output voltage feedback pin is combined with the IC shutdown function. Combining multiple functions into a single pin reduces the pin count of the IC package required to perform the same function. Reduction of the pin count of the DC to DC boost converter effectively reduces the size of the package required for the DC to DC boost converter, supporting a smaller size for the electronic devices using the boost converters.

What is claimed is:

1. An integrated circuit having a reduced pin count, comprising:
a pin coupled to receive an analog input signal and a digital input signal;
a first level detection circuit responsive to the digital input signal having a first input coupled to the pin; and
a second level detection circuit responsive to the analog input signal having a first input coupled to the pin.

2. The integrated circuit of claim 1, wherein the first level detection circuit comprises a comparator having a second input coupled to a reference signal and having an output coupled to provide a signal indicative of a first mode of operation.

3. The integrated circuit of claim 1, wherein the second level detection circuit comprises an operational amplifier having a second input coupled to a reference signal and having an output coupled to provide an analog control signal responsive to the analog input signal.

4. The integrated circuit of claim 1, wherein the second level detection circuit comprises a comparator having a second input coupled to a reference signal and having an output coupled to provide a digital control signal responsive to the analog input signal.

5. In an integrated circuit, a voltage conversion circuit responsive to first and second signals present at a multi-function pin of the integrated circuit, the voltage conversion circuit comprising:
a first level detection circuit having an input coupled to the multi-function pin and having an output responsive to first and second levels of the first signal; and
a second level detection circuit having an input coupled to the multi-function pin.

6. The voltage conversion circuit of claim 5, wherein the first level detection circuit comprises a comparator having a second input coupled to a reference signal.

7. The voltage conversion circuit of claim 5, wherein the second level detection circuit comprises an operational amplifier having a second input coupled to a reference signal and having an output coupled to provide an analog regulation control signal responsive to the second signal.

8. The voltage conversion circuit of claim 5, wherein the second level detection circuit comprises a comparator having a second input coupled to a reference signal and having an output coupled to provide a digital regulation control signal responsive to the second signal.

9. A method of producing multiple operational states of a voltage converter using a single control input, comprising:
using the single control input to initiate a first operational state of the voltage converter;
responding to an analog signal present at the single control input during the first operational state; and
responding to a digital signal present at the single control input to initiate a second operational state.

10. The method of claim 9 wherein using the single control input to initiate the first operational state of the voltage converter comprises biasing a semiconductor device with a signal present at the single control input.

11. The method of claim 9 wherein responding to an analog signal present at the single control input during the first operational state comprises:
monitoring a magnitude of the analog signal; and
providing an analog regulation control signal in response to the magnitude of the analog signal.

12. The method of claim 9 wherein responding to an analog signal present at the single control input during the first operational state comprises:
monitoring a magnitude of the analog signal; and
providing a digital regulation control signal in response to the magnitude of the analog signal.

13. The method of claim 9 wherein responding to a digital signal present at the single control input to initiate a second operational state comprises:
monitoring a magnitude of the digital signal;
providing a digital control signal in response the magnitude of the digital signal.

14. A method of controlling dual operational states of a voltage regulation circuit from a single control input comprising:
establishing a shutdown state when the single control input is below a first reference level; and
establishing a voltage regulation state when the single control input is above the first reference level.

15. The method of claim 14 wherein establishing the shutdown state comprises monitoring a magnitude of the single control input with a comparator.

16. The method of claim 14 wherein establishing the voltage regulation state comprises:
monitoring a magnitude of the single control input with an operational amplifier; and
providing an analog regulation control signal in response to the magnitude of the signal control input.

17. The method of claim 14 wherein establishing the voltage regulation state comprises:
monitoring a magnitude of the single control input with a comparator; and
providing a digital regulation control signal in response to the magnitude of the signal control input.
